(19) United States
(12) Patent Application Publication
(10) Pub. No.: US 2012/0004979 A1
(43) Pub. Date: Jan. 5, 2012

(54) INTRASTRUCTURE FOR BUCKET TESTING IN GUARANTEED DELIVERY OF ONLINE ADVERTISING

(75) Inventors: Tarun Bhatia, Burbank, CA (US); Jayavel Shanmugasundaram, Santa Clara, CA (US)

(73) Assignee: Yahoo! Inc., Sunnyvale, CA (US)

(21) Appl. No.: 12/829,775

(22) Filed: Jul. 2, 2010

(51) Int. Cl. G06Q 30/00

(52) U.S. Cl. 705/14.42; 705/14.73; 705/14.46

(57) ABSTRACT

Techniques are provided relating to conducting bucket testing in connection with guaranteed delivery online advertising associated with an online advertising marketplace. Techniques are provided in which advertising supply, demand, or both are partitioned into buckets. Operating policies are established for each of the buckets, in which the operating policies for each of the buckets differ. Following serving of advertisements in accordance with the operating policies, difference is measured in at least one outcome, between buckets.

### BACKGROUND

Bucket testing is widely adopted and accepted, as well as valuable, for example, for non-guaranteed delivery online advertising models, including sponsored search and other auction-based allocation mechanisms for display advertisements. In non-guaranteed modes of advertisement delivery, bucket testing implementations are relatively straight-forward, since serve-time information predominately dictates allocation of inventory to the provisioned demand, via volume, bids, and performance estimates, for example.

Guaranteed delivery of advertisements, by contrast, can require coordination across a sophisticated set of functional components, each operating at different cycles. Brand advertisers, among other types of advertisers, often prefer the guaranteed delivery mode for delivering advertisements to online users. Guaranteed delivery, which can include, for example, agreements or contracts with advertisers specifying delivery of, for example, a certain number of impressions, can provide more certainty and control over campaign execution. This can include, for example, where and under what contexts the brand advertisements appear, who is exposed to the advertisements, how many times they are exposed, the number of impressions the campaign will receive, and how much marketing budget will be spent. All of these can be critical elements for a brand marketer to control, and the guaranteed delivery model can be the natural choice for advertisers seeking such control. Furthermore, brand advertisers represent a significant share of display advertising.

There is a need for new techniques relating to bucket testing in online advertising, including techniques for enabling, providing, and leveraging bucket testing.

### SUMMARY

In some embodiments, techniques are provided relating to conducting bucket testing in connection with guaranteed delivery online advertising associated with an advertising marketplace, whether auction-based or otherwise. Techniques are provided in which advertising supply, demand, or both are partitioned into buckets. Operating policies are established for each of the buckets, in which the operating policies for each of the buckets differ. Following serving of advertisements in accordance with the operating policies, difference is measured in at least one outcome, between buckets. It is to be understood that the serving in accordance with the operating policies does not imply that the operating policies necessarily include serving policies, since operating policies can encompass a wide variety of policies, but only that the operating policies, whatever such operating policies include, were followed or complied with. Some embodiments include utilizing bucket testing to assess impact of at least one of differing querying policies, differing yield, differing revenue, differing inventory booking policies, differing inventory management policies, differing allocation policies, differing forecasting policies, differing pricing policies, and differing serving policies. Furthermore, some embodiments include, following serving of advertisements in accordance with the operating policies, measuring difference in at least one outcome, between the buckets, relating to allocation of advertisements, serving of advertisements, and performance of advertisements, and advertising campaign performance, associated with each of the buckets.

In some embodiments, techniques are provided to facilitate bucket testing in connection with guaranteed delivery online advertising associated with an online advertising marketplace. Operating policies are established for each of the buckets, in which the operating policies for each of the buckets differ. Bucket controller programming logic is used in implementation of the operating policies. Allocation and serving of advertisements is facilitated in accordance with the operating policies.

In some embodiments, techniques are provided relating to conducting bucket testing, relating to advertisement performance or advertisement campaign performance, in connection with guaranteed delivery online advertising associated with an online advertising marketplace. Techniques are provided in which advertising supply, demand, or both are partitioned into buckets. Operating policies are established for each of the buckets, in which the operating policies for each of the buckets differ. Following serving of advertisements in accordance with the operating policies, difference is measured between the buckets, and the difference is used to evaluate differing advertisement performance or differing advertisement campaign performance between the buckets.

Some embodiments include assessing differing creative performance at least in part by serving one or more particular creatives in connection with each bucket and, for each bucket, to subsets of identically targeted users.

Some embodiments include assessing differing advertisement performance or advertising campaign performance, between (1) advertisement performance or advertising campaign performance associated with a control bucket and (2) advertisement performance or advertising campaign performance associated with a treatment bucket. The technique can include, for one or more advertisements or types of advertisements, and for an identically targeted set of users including a subset of users in a control bucket and a subset of users in a treatment bucket, preventing exposure of the subset of users in the control bucket while allowing exposure of the subset of users in the treatment bucket. The technique can further include assessing difference in at least one parameter relating to behavior of users in the control bucket who were prevented from exposure as compared to behavior of users in the treatment bucket who were exposed.

Some embodiments of the invention provide flexible bucket testing techniques, for use with guaranteed delivery advertising, including a variety of partitioning schemes which can be used for different bucket testing according to needs, including concurrently operating and overlapping bucket testing. Furthermore, some embodiments utilize bucket controller programming logic to provide, for example, central or modular control, including, for example, in bucket set-up, operation of different policies between buckets, bucket tear-down, etc., all while minimizing any negative impact on yield while maximizing accuracy and value of experimental results.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention;

FIG. 6 is a flow diagram illustrating a method according to one embodiment of the invention;

FIG. 7 is a flow diagram illustrating a method according to one embodiment of the invention;

FIG. 8 is a block diagram illustrating one embodiment of the invention;

FIG. 9 is a block diagram illustrating one embodiment of the invention;

FIG. 10 is a block diagram illustrating one embodiment of the invention; and

FIG. 11 is a simplified flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

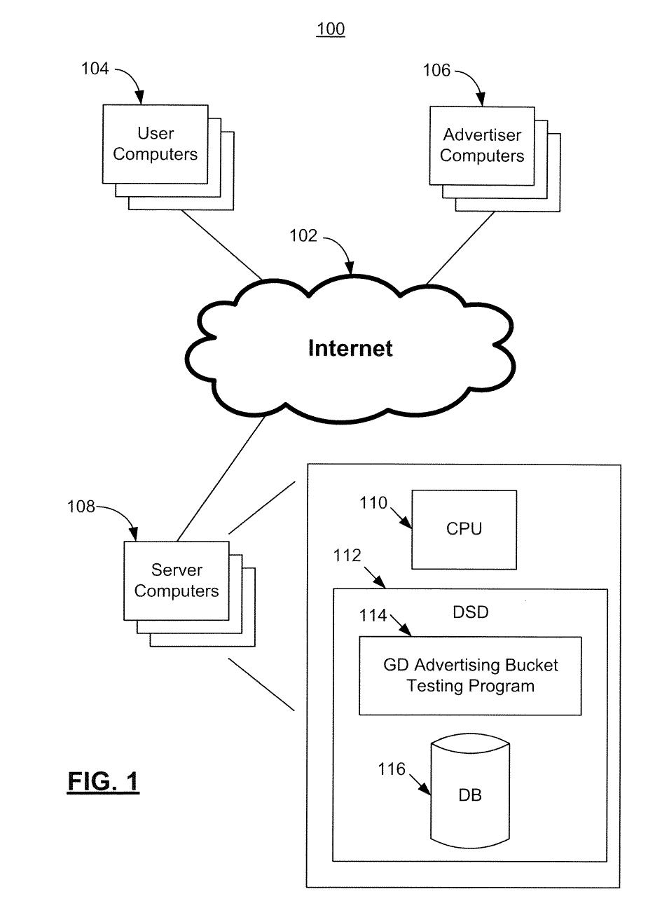

FIG. 1 is distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Guaranteed Delivery (GD) Bucket Testing Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

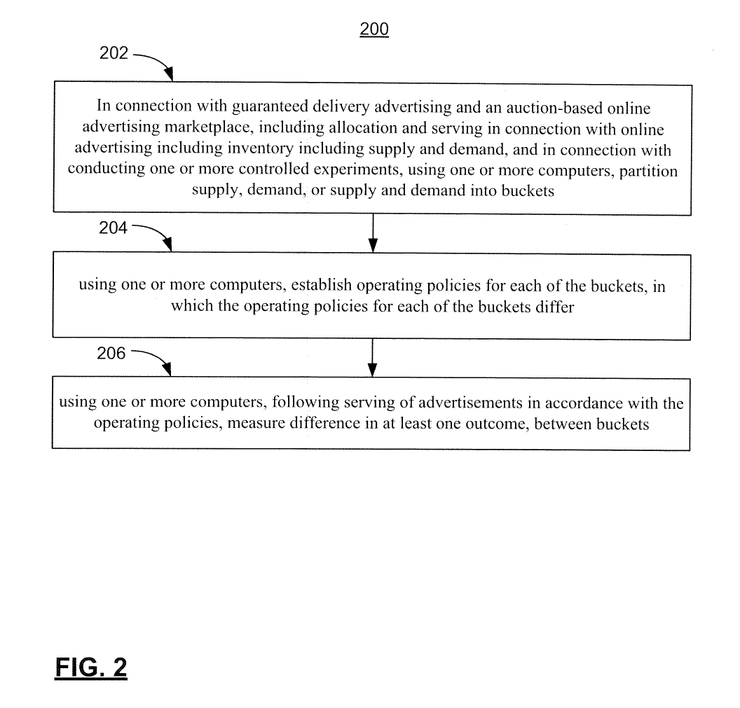

FIG. 2 is a flow diagram illustrating a method 200 according to one embodiment of the invention. At step 202, in connection with guaranteed delivery advertising and an auction-based online advertising marketplace, including allocation and serving in connection with online advertising including inventory including supply and demand, and in connection with conducting one or more controlled experiments, using one or more computers, supply, demand, or supply and demand are partitioned into buckets.

At step 204 using one or more computers, operating policies are established for each of the buckets, in which the operating policies for each of the buckets differ.

At step 206, using one or more computers, following serving of advertisements in accordance with the operating policies, difference is measured in at least one outcome, between buckets.

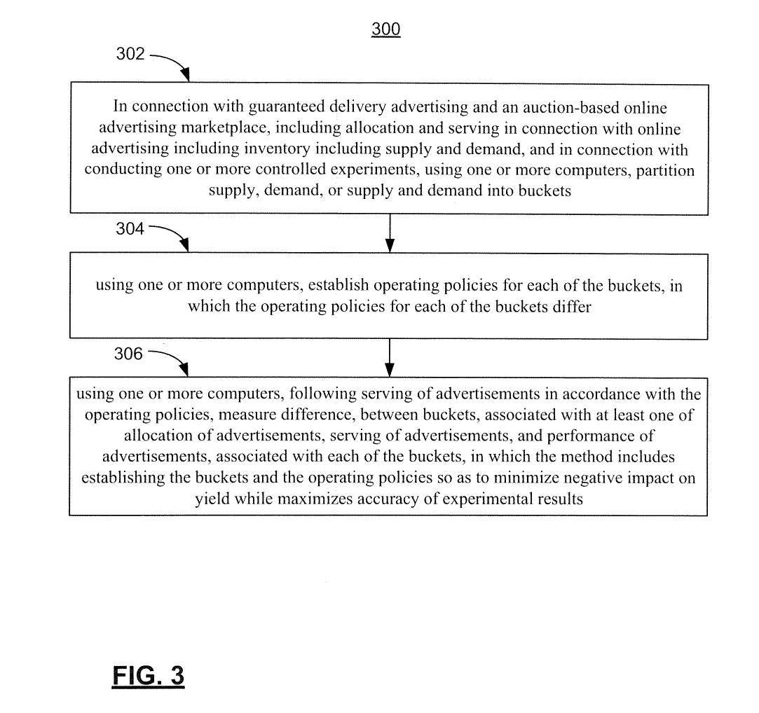

FIG. 3 is a flow diagram illustrating a method 300 according to one embodiment of the invention. Steps 302 and 304 of the method 300 depicted in FIG. 3 are similar to steps 202 and 204 of the method 200 depicted in FIG. 2.

At step 306, using one or more computers, following serving of advertisements in accordance with the operating policies, difference is measured, between buckets, associated with at least one of allocation of advertisements, serving of advertisements, and performance of advertisements, associated with each of the buckets. The method 300 includes establishing the buckets and the operating policies so as to minimize negative impact on yield while maximizes accuracy of experimental results.

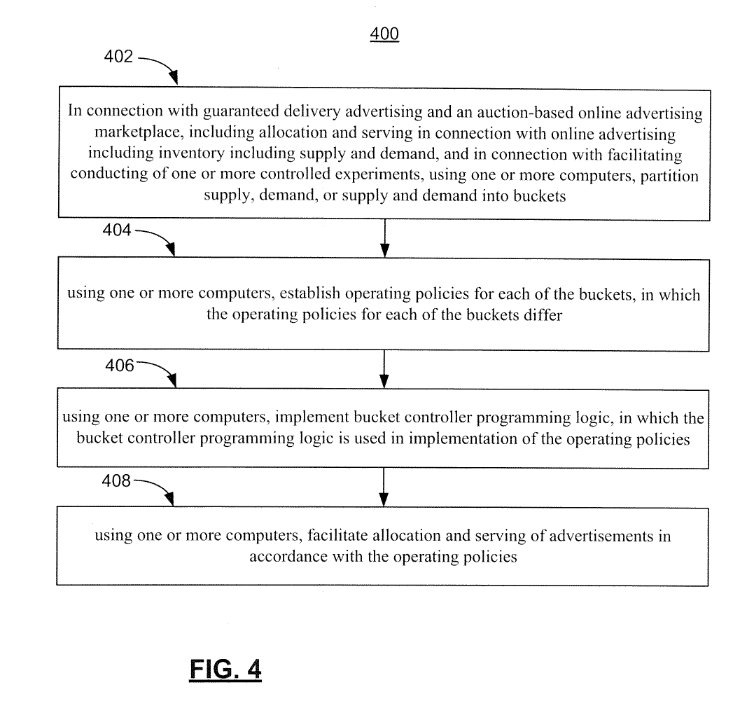

FIG. 4 is a flow diagram illustrating a method 400 according to one embodiment of the invention. At step 402, in connection with guaranteed delivery advertising and an auction-based online advertising marketplace, including allocation and serving in connection with online advertising including inventory including supply and demand, and in connection with facilitating conducting of one or more controlled experiments, using one or more computers, supply, demand, or supply and demand are partitioned into buckets.

At step 404, using one or more computers, operating policies are established for each of the buckets, in which the operating policies for each of the buckets differ.

At step 406, using one or more computers, bucket controller programming logic is implemented, in which the bucket controller programming logic is used in implementation of the operating policies.

Step 408 includes, using one or more computers, facilitating allocation and serving of advertisements in accordance with the operating policies.

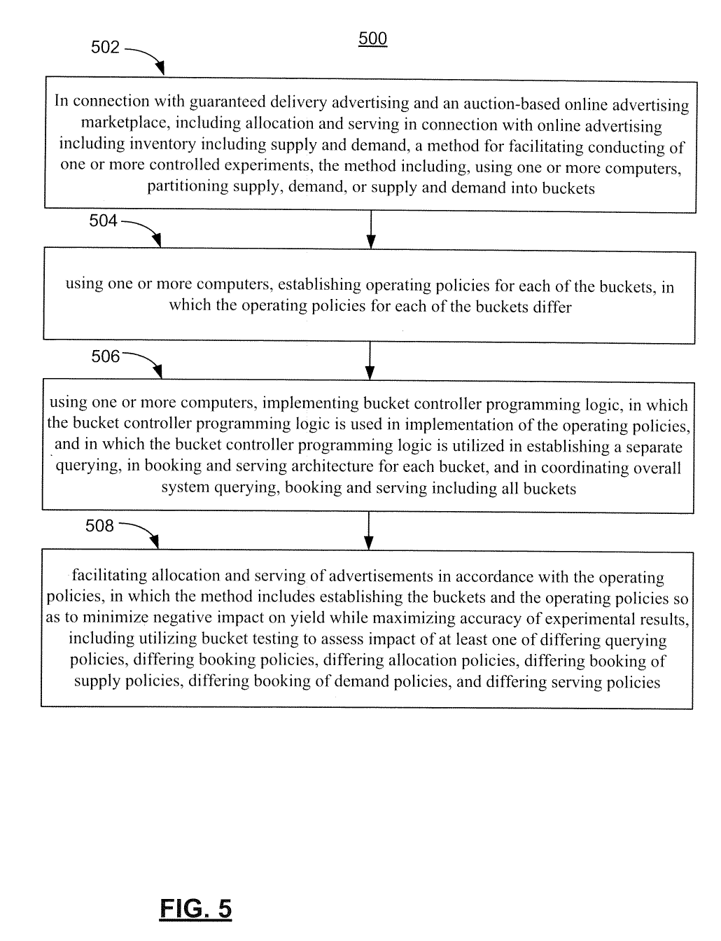

FIG. 5 is a flow diagram illustrating a method 500 according to one embodiment of the invention. Steps 502 and 504 of the method 500 depicted in FIG. 5 are similar to steps 402 and 404 of the method 400 depicted in FIG. 4.

At step 506, using one or more computers, bucket controller programming logic is implemented, in which the bucket controller programming logic is used in implementation of the operating policies. The bucket controller programming logic is utilized in establishing a separate querying, in booking and serving architecture for each bucket, and in coordinating overall system querying, booking and serving including all buckets.

Step 508 includes facilitating allocation and serving of advertisements in accordance with the operating policies. The method 500 includes establishing the buckets and the operating policies so as to minimize negative impact on yield while maximizing accuracy of experimental results. The method 500 further includes utilizing bucket testing to assess impact of at least one of differing querying policies, differing booking policies, differing allocation policies, differing booking of supply policies, differing booking of demand policies, differing inventory management policies, and differing serving policies.

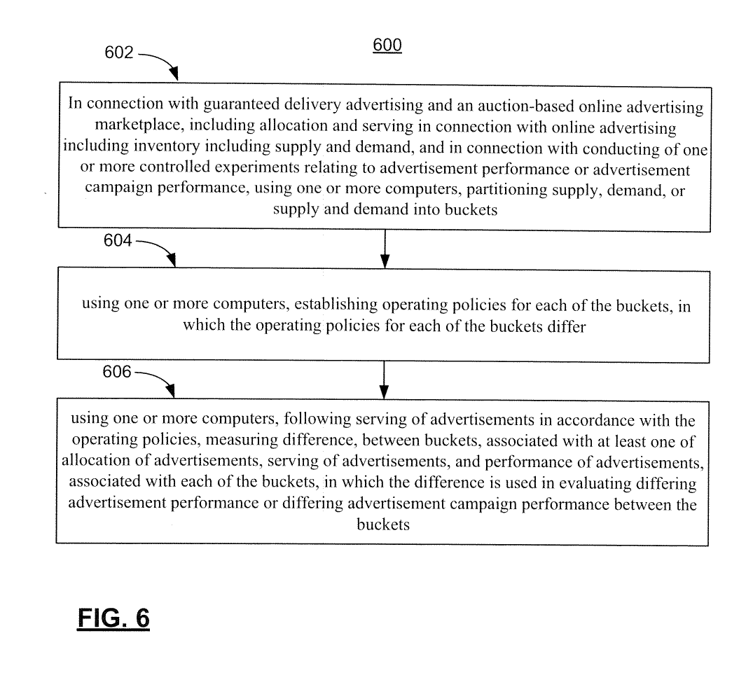

FIG. 6 is a flow diagram illustrating a method 600 according to one embodiment of the invention. At step 602, in connection with guaranteed delivery advertising and an auction-based online advertising marketplace, including allocation and serving in connection with online advertising including inventory including supply and demand, and in connection with conducting of one or more controlled experiments relating to advertisement performance or advertisement campaign performance, using one or more computers, supply, demand, or supply and demand are partitioned into buckets.

At step 604, using one or more computers, operating policies are established for each of the buckets, in which the operating policies for each of the buckets differ.

At step 606, using one or more computers, following serving of advertisements in accordance with the operating policies, difference is measured, between buckets, associated with at least one of allocation of advertisements, serving of advertisements, and performance of advertisements, associated with each of the buckets, in which the difference is used in evaluating differing advertisement performance or differing advertisement campaign performance between the buckets.

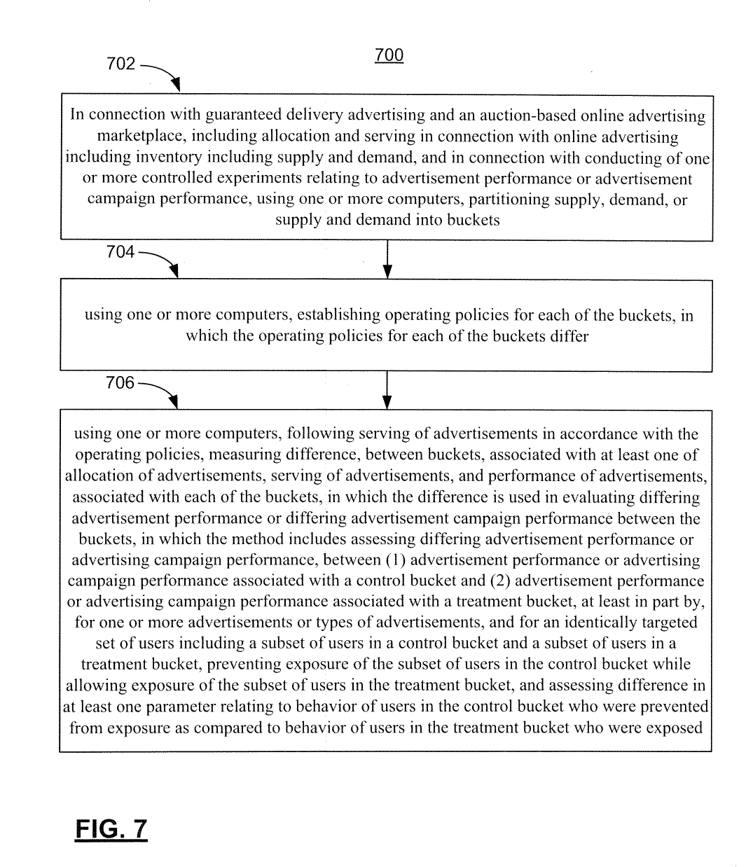

FIG. 7 is a flow diagram illustrating a method 700 according to one embodiment of the invention. Steps 702 and 704 of the method 700 depicted in FIG. 7 are similar to steps 602 and 604 of the method 600 depicted in FIG. 6.

At step 706, using one or more computers, following serving of advertisements in accordance with the operating policies, difference is measured, between buckets, associated with at least one of allocation of advertisements, serving of advertisements, and performance of advertisements, associated with each of the buckets, in which the difference is used in evaluating differing advertisement performance or differing advertisement campaign performance between the buckets. The method 700 includes assessing differing advertisement performance or, advertising campaign performance, between (1) advertisement performance or advertising campaign performance associated with a control bucket and (2) advertisement performance or advertising campaign performance associated with a treatment bucket, at least in part by, for one or more advertisements or types of advertisements, and for an identically targeted set of users including a subset of users in a control bucket and a subset of users in a treatment bucket, preventing exposure of the subset of users in the control bucket while allowing exposure of the subset of users in the treatment bucket. The method 700 further includes assessing difference in at least one parameter relating to behavior of users in the control bucket who were prevented from exposure as compared to behavior of users in the treatment bucket who were exposed.

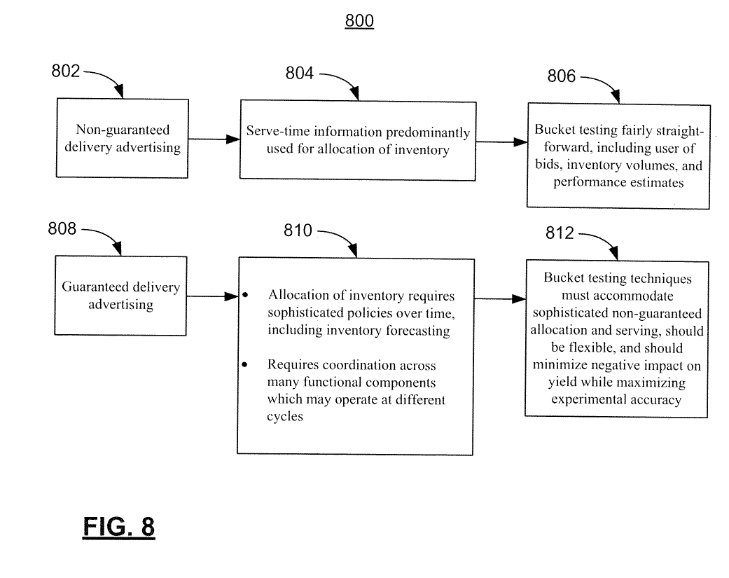

FIG. 8 is a block diagram 800 illustrating one embodiment of the invention. Block 802 represents non-guaranteed advertising systems. As represented by block 804, generally in such systems, serve-time information is predominantly used for allocation of inventory. As represented by block 806, with such systems, bucket testing is generally fairly straight-forward, and generally includes user of bids, inventory volumes, and performance estimates.

Block 808 represents guaranteed delivery advertising systems. As represented by block 810, in such systems, allocation of inventory generally requires sophisticated allocation policies over time, including inventory forecasting. Furthermore, such systems generally require coordination across many functional components which may operate at different cycles. As represented by block 812, with such systems, bucket testing techniques, according to some embodiments of the invention, must accommodate sophisticated non-guaranteed allocation and serving, should be flexible, and should minimize negative impact on yield while maximizing experimental accuracy.

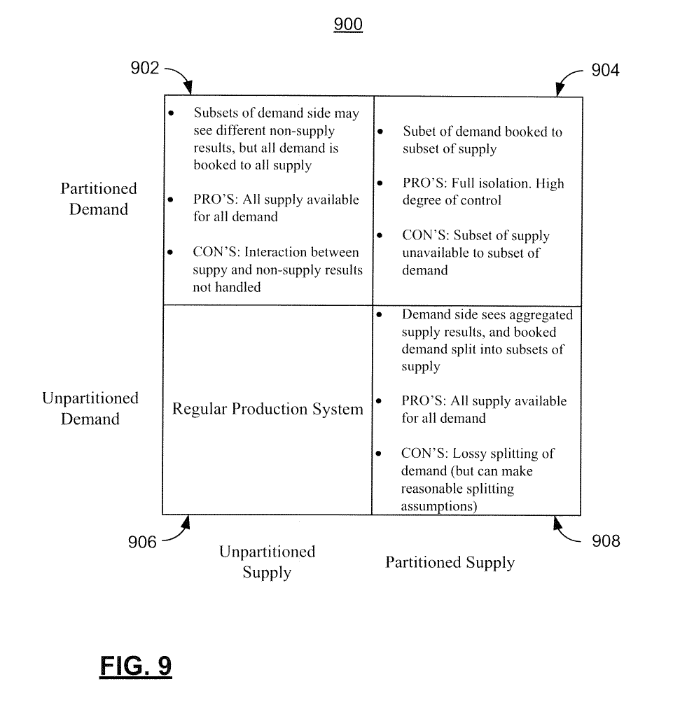

FIG. 9 is a block diagram 900 illustrating one embodiment of the invention. Generally, the diagram 900 represents a conceptual bucket testing space according to embodiments of the invention. In some embodiments. In general terms, buckets can correspond to partitioning along the supply or demand dimensions. Some embodiments of the invention contemplate partitioning of supply but not demand, partitioning of demand but not supply, and partitioning of both supply and demand. Furthermore, some embodiments of the invention contemplate running multiple bucket tests concurrently and at different cycles. Generally, some embodiments of the invention contemplate, for a particular bucket test or bucket testing objective, choosing the optimal partitioning scenario, generally to minimize reduction in yield while maximizing experimental accuracy.

Block 906 represents no partitioning of either supply or demand, which generally represents regular production system conditions. In some embodiments of the invention, this can serve as or apply to a baseline or control set or bucket.

Block 902 represents partitioned demand but unpartitioned supply. Generally, under these conditions, subsets of the demand side may see different non-supply results, but all demand is booked to all supply. Generally, advantages of this scenario include that all supply is available for all demand. Generally, disadvantages include that interaction between supply and non-supply results are not handled.

Generally, partitioned demand but not supply can be the case when some part of the demand supply is managed differently than others. This could include, for example, when a new policy is adopted to respond to demand side requests for querying inventory or price, or to book inventory. A goal, in testing using this form of partitioning, may be to understand the demand side response to such modifications. For example, one set of account representatives could be shown prices of inventory as determined by a new pricing policy, and the results could be used to guide rollout of the new pricing scheme for the entire set of accounts. In such a case, subsets of demand may see different attributes of the same supply, such as by seeing the same inventory but different prices, and all demand can still access all supply. This form of partitioning can require careful managing between pricing and availability interaction.

Block 908 represents partitioned supply but unpartitioned demand. Generally, under conditions, demand side sees aggregated supply results, and booked demand is split into subsets of supply. Generally, advantages of this scenario include that all supply is available for all demand. Generally, disadvantages include lossy splitting of demand, although reasonable splitting assumptions can be made.

Generally, partitioned supply but not demand can be the case when some part of supply inventory is managed differently than others. This could include situations, for example, such as when a new inventory management policy is adopted, such as through a new configuration of existing components, a new settings profile of configurable parameters in algorithms, or new sub-components altogether, and in which the resulting new set of policies are implemented within a bucket. Inventory could include, for example, select property positions or placements, or certain audience segments that are exposed to this treatment. In such forms of partitioning, careful management can be required to preserve supply integrity despite the partitioning. For example, demand requests, such as queries for available inventory, or request to book guarantees in the future, should not artificially face inaccessible pockets of supply as a result of the buckets. Logic may be required to coordinate inventory queries and booking requests across partitioning. A goal can be to manage so as to minimize any loss resulting from partitioning of supply, and all supply should still be accessible to all qualified demand.

Block 904 represents partitioned supply and partitioned demand. Generally, advantages of this scenario include full isolation and a high degree of control. Generally, disadvantages include that a subset of supply is unavailable to a subset of demand, which can disallow support of certain guaranteed delivery products in some instances.

Partitioning of supply and demand can be the case where a subset of demand is booked to a subset of supply, and can be the most complex form of partitioning. It can provide full isolation, which can be desirable for maximizing experimental control, but it can be sub-optimal from the perspective of optimizing yield.

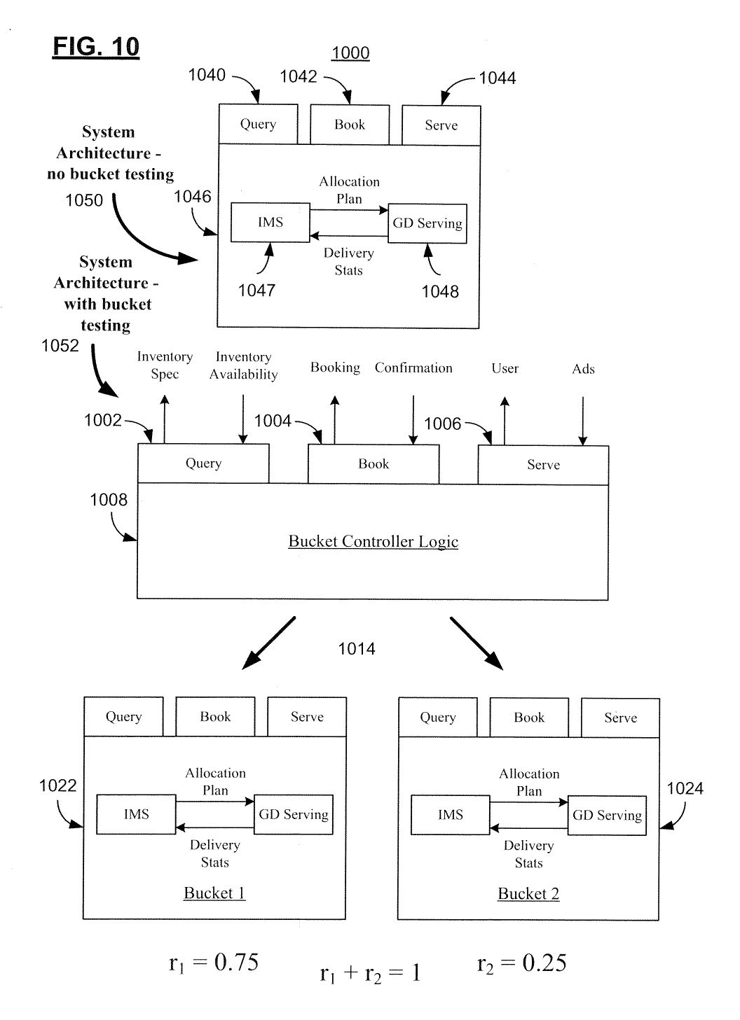

FIG. 10 is a block diagram 1000 illustrating one embodiment of the invention. Some embodiments of the invention use bucket controller programming logic, or a bucket controller programming logic module, in, for example, implementing and handling bucket testing, which can include operating numerous concurrent bucket tests operating at different cycles, while minimizing negative impact on yield and maximizing accuracy of experimental results.

Depicted in FIG. 10 are a system architecture without bucket testing 1050, and a system architecture including or enabling bucket testing 1052, according to one embodiment of the invention.

The system architecture without bucket testing 1050 includes an inventory management and serving (IMS) component or aspect 1047 and a guaranteed delivery serving, or GD serving, aspect or component 1048. The system architecture includes components or aspects for handling query 1040, booking 1042 and serving 1044 elements or aspects. Allocation plan information is passed from the IMS component 1047 to the serving component 1048, and delivery statistics information is passed from the GD serving component 1048 to the IMS component 1047.

The system architecture with or enabling bucket testing 1052 includes a bucket controller logic aspect, module, or component 1008, and two buckets, bucket one 1022 and bucket two 1024. While conceptually depicted separately, the bucket controller logic component 1008 could be incorporated, or partially incorporated, into, for example, general inventory management and serving (IMS) associated with the overall advertising system.

As depicted, the bucket controller logic component 1008 is used in managing split logic between the two buckets 1022, 1024, according to a specified ratio, as well as managing differing operating policies between the two buckets 1022, 1024. For example, as depicted, a split ratio of 0.75 to 0.25 is utilized between bucket one 1022 and bucket two 1024, respectively. Each of the two buckets 1022, 1024 includes similar components to that of the system architecture without bucket testing 1052. However, each of the two buckets 1022, 1024 utilize differing operating policies, as managed by the bucket controller logic component 1008.

In some embodiments, the system architecture with bucket testing 1052, including use of a bucket testing logic component 1008, as well as buckets 1022, 1024 to implement differing operating policies, facilitates organized and sophisticated bucket testing as may be required in guaranteed delivery advertising systems.

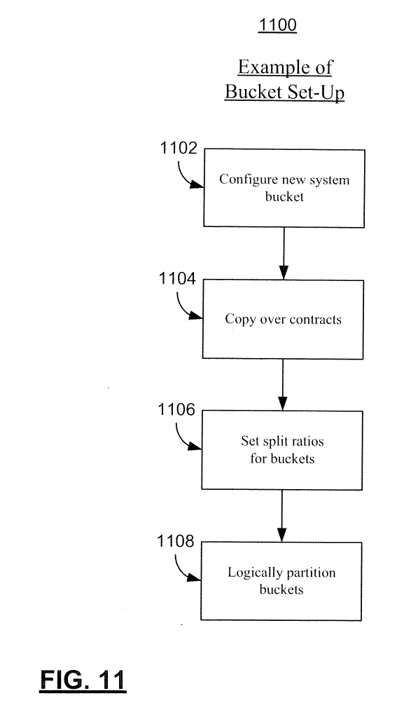

FIG. 11 is a simplified flow diagram illustrating a method 1100 according to one embodiment of the invention. The method 1100 depicted in FIG. 11 relates to bucket set-up, and may be implemented by a bucket testing logic component. The method is merely illustrative of one embodiment of one function of a bucket testing logic component. Of course, a bucket testing logic component may also handle or implement many other functions.

At step 1102, a new system bucket is configured, which could include assigning associated operating policies.

At step 1104, contracts, which can include guaranteed delivery agreements associated with advertisers, are copied to be usable in connection with the new bucket.

At step 1106, split ratios are set for buckets, including the new bucket.

At step 1108, buckets, including the new bucket, are logically partitioned.

Some embodiments of the invention include providing methods and systems to allow or facilitate conducting of a multitude of concurrent bucket tests pertaining to the guaranteed delivery of online advertising. Bucket testing can include experimentation, such as controlled experimentation, or learning, to allow determination of the effect, or outcome, of conscious choices or treatments in terms of a measured response, for example. Outcomes can include, among other things, yield improvements realized that are attributed to inventory management and pricing policies, such as for an advertising network. Outcomes can further include, among other things, yield improvements from differing allocation policies. Herein, the terms “policy” and “policies” are intended to broadly include, among other things, rules, logic, programming, algorithms, procedures, courses or plans of action or non-action, etc. Outcomes can further include, among other things, outcomes relating to advertisement or campaign performance, such in connection with any of various parameters or criteria, including, for example, targeting criteria, advertisement creative features, etc, for example, in association with an advertiser, including an agent or proxy of an advertiser.

In some embodiments, efficient bucket testing can include, among other things, managing contention among advertiser-associated contracts (booked and forecasted), forecasting of supply with various targeting attributes, forecasting demand across various types of guaranteed products, optimal allocation of forecasted supply to booked and forecasted demand streams, and selection of campaigns and creatives in response to advertisement serving opportunities in real time or near real time. Relevant decisions and determinations can span time periods in advance leading up to the serving moment for a serving opportunity, or the active flight for a campaign.

Coordination of policies, plans and strategies across functional components operating at different forward-looking periodic cycles, for instance, can present complication which must be well managed for meaningful or optimal bucket testing in guaranteed delivery advertising. The vulnerability of guaranteed delivery to decisions implemented across functions over time can add complexity in the form of strong first order signals on both supply, including, for example, in relation to user visits or serving opportunities, and demand, including, for example, in relation to advertiser or sales booking. As such, some embodiments of the invention include, for example, incorporation of first and second order effects of a treatment in a bucket on supply and demand.

Some embodiments of the invention provide flexible bucket testing techniques for use with guaranteed delivery advertising, including a variety of partitioning schemes which can be used for different bucket tests according to needs, including concurrently operating and overlapping bucket tests. Partitioning schemes are utilized that enable flexible support for all types of guaranteed delivery products (for example, exclusive campaigns), while maximizing isolation of the effects of different buckets. Furthermore, some embodiments utilize bucket controller programming logic to provide, for example, central or modular control, including, for example, bucket set-up, operation of different policies between buckets, bucket tear-down, bucket re-size, etc. This may be done while minimizing also any negative impact on yield and maximizing accuracy of experimental results, including minimizing any interference between concurrent bucket tests, for example. Results can be utilized, for example, by advertisers including campaign managers and agents, advertising networks, publishers and agents of publishers, or other entities, in assessing various parameters, and changes in parameters, in connection with online advertising, or management or operation of online advertising systems, for example.

Although bucket testing is described herein primarily with regard to application in guaranteed delivery advertising, it is to be understood that embodiments described herein can also be used in non-guaranteed delivery or other forms of advertising, as well as in both or mixed guaranteed delivery and non-guaranteed delivery, for example.

Furthermore, it is to be understood that embodiments of the invention include incorporation of offline elements, aspects, and outcomes. For example, advertisement or advertising campaign related outcomes could include offline measures or parameters, such as in-store sales, for example.

While the invention is described with reference to the above drawings, the drawings are intended to be illustrative, and the invention contemplates other embodiments within the spirit of the invention.

1. In connection with guaranteed delivery advertising and an online advertising marketplace, including allocation and serving in connection with online advertising including inventory including supply and demand, a method for conducting one or more controlled experiments, the method comprising:
using one or more computers, partitioning supply, demand, or supply and demand into buckets;
using one or more computers, establishing operating policies for each of the buckets, wherein the operating policies for each of the buckets differ; and
using one or more computers, following serving of advertisements in accordance with the operating policies, measuring difference in at least one outcome, between the buckets.

2. The method of claim 1, comprising utilizing bucket testing to assess impact of differing operating policies, and wherein differing operating policies can include at least one of differing querying policies, differing yield, differing revenue, differing inventory booking policies, differing inventory management policies, differing allocation policies, differing forecasting policies, differing pricing policies, and differing serving policies.

3. The method of claim 1, comprising, following serving of advertisements in accordance with the operating policies, measuring difference in at least one outcome, between the buckets, relating to allocation of advertisements, serving of advertisements, and performance of advertisements, and advertising campaign performance, associated with each of the buckets.

4. The method of claim 1, comprising establishing the buckets and the operating policies so as to minimize negative impact on yield while maximizing accuracy of experimental results.

5. The method of claim 1, comprising facilitating serving of advertisements in accordance with the operating policies.

6. The method of claim 1, comprising partitioning supply but not demand.

7. The method of claim 1, comprising partitioning demand but not supply.

8. The method of claim 1, comprising partitioning demand and partitioning supply.

9. The method of claim 1, comprising operating two or more bucket testing experiments simultaneously, while eliminating or minimizing impact of each of the bucket testing experiments on each other.

10. The method of claim 1, comprising utilizing a partitioning scheme that maximizes enabling support for guaranteed delivery products, including exclusives.

11. The method of claim 1, comprising utilizing bucket testing to assess impact of inventory management policies.

12. The method of claim 1, comprising utilizing bucket testing to assess impact on least one of advertisement performance, performance of one or more creative features, and advertising campaign performance.

13. The method of claim 1, comprising offering bucket testing to advertisers while setting up guaranteed delivery advertising campaigns.

14. The method of claim 1, wherein performing bucket testing comprises coordinating multiple functional components of inventory management and serving operating at different cycles.

15. The method of claim 1, comprising utilizing bucket testing control programming logic in implementing bucket testing.

16. A system, in connection with guaranteed delivery advertising and an online advertising marketplace, including allocation and serving in connection with online advertising including inventory including supply and demand, a method for conducting one or more controlled experiments, the method comprising:
one or more server computers coupled to a network; and
one or more databases coupled to the one or more server computers;
wherein the one or more server computers are for:
partitioning supply, demand, or supply and demand into buckets;
establishing operating policies for each of the buckets, wherein the operating policies for each of the buckets differ; and
following serving of advertisements in accordance with the operating policies, measuring difference, between the buckets, associated with at least one of allocation of advertisements, serving of advertisements, and performance of advertisements, associated with each of the buckets.

17. The system of claim 15, comprising facilitating serving of advertisements according to the policies.

18. The system of claim 15, comprising serving of advertisements according to the policies.

19. The system of claim 15, comprising utilizing bucket testing control programming logic in implementing bucket testing.

20. A computer readable medium or media containing instructions for executing a method, in connection with guaranteed delivery advertising and an online advertising marketplace, including allocation and serving in connection with online advertising including inventory including supply and demand, a method for conducting one or more controlled experiments, the method comprising:
using one or more computers, partitioning supply, demand, or supply and demand into buckets;
using one or more computers, establishing operating policies for each of the buckets, wherein the operating policies for each of the buckets differ; and
using one or more computers, following serving of advertisements in accordance with the operating policies, measuring difference, between the buckets, associated with at least one of allocation of advertisements, serving of advertisements, and performance of advertisements, associated with each of the buckets;
comprising establishing the buckets and the operating policies so as to minimize negative impact on yield while maximizing accuracy of experimental results.
